(19) United States
(12) Patent Application Publication
(10) Pub. No.: US 2018/0090253 A1
(43) Pub. Date: Mar. 29, 2018

(54) INTEGRATED GAP SENSING ELECTROMAGNETIC RELUCTANCE ACTUATOR

(71) Applicant: Apple Inc., Cupertino, CA (US)

(72) Inventors: Teera Songatikamas, San Jose, CA (US); Joseph C. Doll, Cupertino, CA (US); Matthew A. Bigarani, San Jose, CA (US)

(73) Assignee: Apple Inc., Cupertino, CA (US)

(21) Appl. No.: 15/693,088

(22) Filed: Aug. 31, 2017

Related U.S. Application Data
(60) Provisional application No. 62/399,277, filed on Sep. 23, 2016.

(51) Int. Cl. H01F 7/18; G06F 3/01

(52) U.S. Cl. CPC H01F 7/1844; H01F 2007/185; G06F 3/016

(57) ABSTRACT

In an embodiment, a system comprises: a electromagnet having a core and a coil wrapped around the core; and a gap sensing circuit coupled to the coil, the gap sensing circuit operable to determine a gap distance between the electromagnet and a ferromagnetic target based on a change of inductance of the coil.

### CROSS-REFERENCE TO RELATED APPLICATION

This application claims priority to U.S. Provisional Application No. 62/399,277, filed Sep. 23, 2016, the entire contents of which are incorporated herein by reference.

### TECHNICAL FIELD

This disclosure relates generally to electromagnetic reluctance actuators.

### BACKGROUND

An electromagnetic reluctance actuator operates on the principle that a ferromagnetic material, when placed in a magnetic field, will experience a mechanical reluctance force tending to move the material in a direction parallel to the magnetic field. At any point on the surface of the ferromagnetic material the reluctance force is proportional to the square of the magnetic flux density Φ² of the magnetic field experienced at that point, as shown in Equation [1]:

$${F}_{rel} = \frac{{φ}^{2}}{2 {μ}_{o} A} , \qquad [ 1 ]$$

where Fᵣₑₗ is reluctance force, A is the pole surface area, Φ is magnetic flux and μₒ is vacuum permeability.

An important feature of an electromagnetic reluctance actuator is the air gap. Equation [2] describes the reluctance force Fᵣₑₗ as a function of the air gap l:

$${F}_{rel} = \frac{1}{2} {μ}_{o} A \frac{{Θ}^{2}}{{l}^{2}} , \qquad [ 2 ]$$

where the magnetomotive force (MMF), Θ=N·i, is produced in a winding of N turns by a current i. Equation [2] makes clear that the reluctance force Fᵣₑₗ is inversely proportional to the square of the air gap l. As the air gap decreases, the reluctance force increases.

Some electronic devices with touch screen displays (e.g., smartphones) include electromagnetic reluctance actuators to provide haptic feedback by activating and deactivating one or more coils in the actuator. In such an application, the actuator generates a reluctance force that “pulls” on a mechanically compliant touch screen display, causing the display to deflect slightly. The elasticity of the touch display provides a restoring force when the coil is deactivated. The deflection can be felt by a user's finger touching the display as haptic feedback.

It has been observed that when a user touches a screen they provide a “preload” force that narrows the air gap, which based on Equation [2] causes the reluctance force to increase. It has also been observed that the reluctance force varies with different user preload forces. Haptic feedback applications often require a constant reluctance force to maintain a consistent haptic feedback user experience.

### SUMMARY

In an embodiment, a system comprises: a electromagnet having a core and a coil wrapped around the core; and a gap sensing circuit coupled to the coil, the gap sensing circuit operable to determine a gap distance between the electromagnet and a ferromagnetic target based on a change of inductance of the coil.

In an embodiment, a method comprises: driving a resonant circuit including a coil to resonance, the coil being an inductive component of an electromagnet; determining a shift in the first frequency due to a change in self-inductance of the coil; and determining a gap distance between a ferromagnetic target and the electromagnet based on the shift in resonant frequency.

In an embodiment, a system comprises: a mechanically compliant surface; an electromagnet having a core and a coil operable to magnetically couple to the surface, the electromagnetic arranged opposite a ferromagnetic portion of the surface such that a gap is formed between the surface and the electromagnet; and a gap sensing circuit coupled to the coil, the gap sensing circuit operable to determine a gap distance between the electromagnet and the ferromagnetic portion based on a change of self-inductance of the coil or a change in mutual inductance between the coil and a second coil.

Particular embodiments disclosed herein provide one or more of the following advantages. A substantially constant reluctance for can be maintained by sensing changes in air gap distance due to user preload force generated when a user touches a mechanically compliant touch sensitive display. In an embodiment, the air gap sensing mechanism can utilize the coil of an electromagnetic reluctance actuator as an inductive component of a resonant circuit. In other embodiments, an additional inductor coil or capacitive sensor can be used for air gap sensing.

The details of the disclosed embodiments are set forth in the accompanying drawings and the description below. Other features, objects and advantages are apparent from the description, drawings and claims.

### DESCRIPTION OF DRAWINGS

FIGS. 1A and 1B illustrate a haptic feedback application that uses an electromagnetic reluctance actuator to deflect a touch display, according to an embodiment.

FIG. 2A illustrates a electromagnetic reluctance system with an integrated sensor, according to an embodiment.

FIG. 2B is a schematic diagram of a resonant circuit for detecting shifts in resonant frequency for the electromagnetic reluctance system shown in FIG. 2A, according to an embodiment.

FIG. 2C is a plot of resonant frequencies to illustrate resonant frequency shift, according to an embodiment.

FIG. 3A is a schematic diagram illustrating mutual inductance as a function of air gap distance, according to an embodiment.

FIG. 3B is a schematic diagram of a parallel electrical L-C tank model, according to an embodiment.

FIG. 4 is a block diagram of an electromagnetic reluctance system, according to an embodiment.

FIG. 5 is a flow diagram illustrating a process of air gap sensing, according to an embodiment.

The same reference symbol used in various drawings indicates like elements.

### DETAILED DESCRIPTION

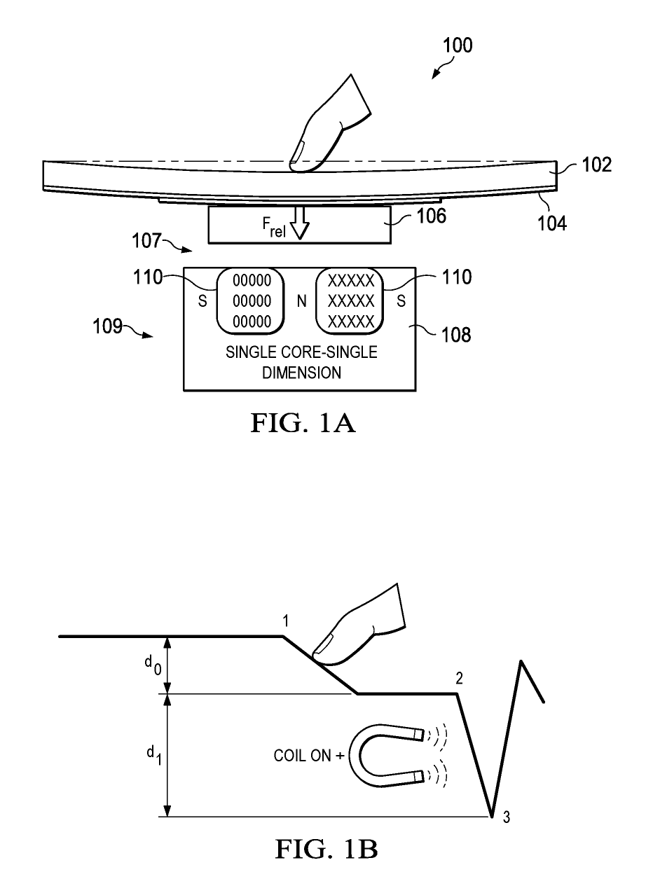

FIG. 1A illustrates a haptic feedback application that uses an electromagnetic reluctance actuator, according to an embodiment. In this example embodiment, a mechanically compliant touch sensitive screen 100 of an electronic device includes cover glass 102 and display stack-up 104. A ferromagnetic attraction plate 106 is attached to display stack-up 104. Positioned under attraction plate 106 is an electromagnet 109 comprising a magnetic core 108 and coil 110. The opposing arrangement of attraction plate 106 and electromagnet 109 results in air gap 107 between attraction plate 106 and electromagnet 109. The magnetic attraction of attachment plate 106 towards electromagnet 109 due to reluctance force Fᵣₑₗ (a “pull” force) is caused by alignment of the magnetic field generated by current flowing through coil 110. The direction of current flow in coil 110 is indicated by the commonly used symbols “x” and “o”. The magnetic flux density is concentrated in the direction of core 108 using a flux concentrator, alternating pole, a Halbach array or the like.

Haptic feedback is provided by the on/off action of coil 110. When a user touches cover glass 102 they receive haptic feedback in the form of a deflection due to the pull force described in Equation [1], followed by an elastic restoring provided by the mechanically compliant touch sensitive screen 100. In many haptic applications it is desirable to maintain a constant reluctance force Fᵣₑₗ to ensure that haptic feedback is properly conveyed through touch sensitive screen 100. As previously described, when a user presses touch sensitive screen 100, a preload force is generated that narrows air gap 107.

Referring to FIG. 1B, the issue of user preload force is further illustrated. At point 1 the user preload force deflects touch sensitive screen 100 by a distance do and at point 2 coil 110 is activated and touch screen 100 is deflected further by a distance d₁. Accordingly, the user preload force biases the distance d₀. Given that every user's preload force is different, and the inverse relationship between the reluctance force and air gap distance, the resulting reluctance force varies greatly from user to user, resulting in a different haptic feedback experience for each user. Inconsistency in haptic feedback is very undesirable for many applications.

To correct for user preload force, the air gap can be sensed by measuring the self-inductance L_{c} of coil 110 or using an additional inductor coil or capacitor to sense the gap. The self-inductance of coil 110 is given by Equation [3]:

$${L}_{c} = \frac{{μ}_{o} {AN}^{2}}{l} , \qquad [ 3 ]$$

where L_{c} is self-inductance of the coil with N ampere turns, A is the pole surface area and μₒ is vacuum permeability. As can be observed from Equation [3], the self-inductance L_{c} is a function of the gap distance. It follows then that the gap distance can be determined by sensing the self-inductance L_{c} of the electromagnet coil.

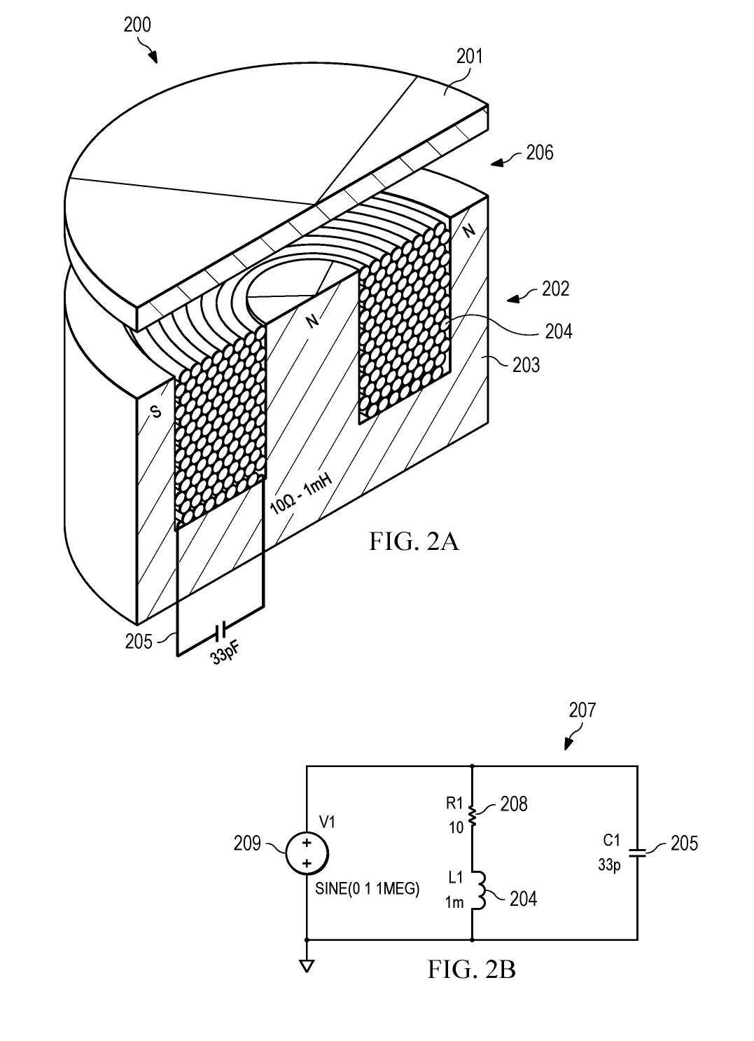

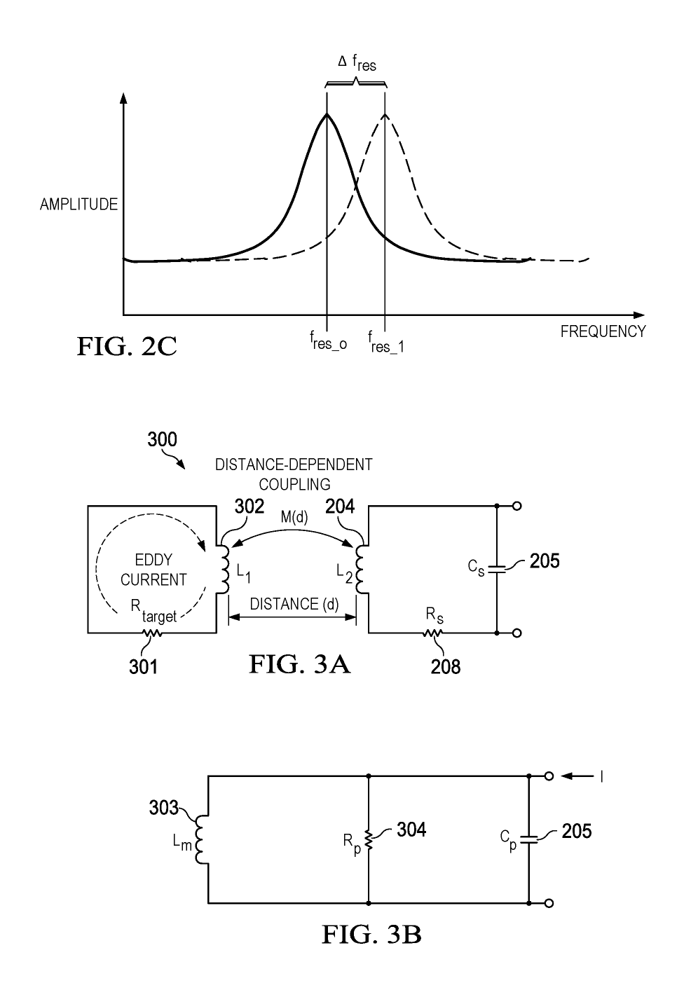

FIG. 2A illustrates a electromagnetic reluctance system 200 with an integrated sensor, according to an embodiment. System 200 includes ferromagnetic target 201 and electromagnet 202. Electromagnet 202 includes magnetic core 203 and coil 204. Air gap 206 is between target 201 and electromagnet 202. Capacitor 205 coupled in parallel with coil 204. Coil 204 and capacitor 205 form part of a resonant circuit, as described in reference to FIG. 2B

FIG. 2B is a schematic diagram of a resonant circuit 207 for detecting shifts in resonant frequency for the electromagnetic reluctance system 200 shown in FIG. 2A, according to an embodiment. In the example shown, self-inductance L₁ of coil 204 is 1 mH, series resistance 208 (R₁) of coil 204 is 10 ohms and sensor capacitance 205 (C₁) is 33 pF. Note that the sensor capacitance C₁ shown in FIG. 2B can be included in a lumped capacitance Cₚ. Cₚ can include C₁ and coil capacitance, which can include the capacitance between turns, the capacitance between layers, the capacitance between windings and stray capacitance. However, keeping turns to a minimum will keep Cₚ to a minimum.

As shown in FIG. 2B, L₁ and C₁ form part of resonant circuit 207. A sinusoidal voltage source 209 (V₁) can be applied to resonant circuit 207 to induce resonance in resonance circuit 207 at a frequency determined by the frequency of sinusoidal voltage source 209, which in this example is 1 Mhz. The nominal resonant frequency fᵣₑₛ_{_}ₒ of resonant circuit 207 is given by Equation [4]:

$${f}_{res \_ o} = \frac{1}{2 π \sqrt{{L}_{1}} {C}_{1}} \qquad [ 4 ]$$

As shown in FIG. 2C, when the self-inductance L₁ of coil 204 changes as a function of the air gap 206 distance changing, a new resonant frequency fᵣₑₛ_{_}₁ results. The difference of the new resonant frequency fᵣₑₛ_{_}₁ and the nominal resonant frequency fᵣₑₛ_{_}₀ is the delta frequency Δfᵣₑₛ shown in Equation [5]:

Δfᵣₑₛ=|fᵣₑₛ_{_}₁−fᵣₑₛ_{_}ₒ| [5]

The delta frequency Δfᵣₑₛ can be mapped to a look-up table of delta frequency or absolute frequency to air gap distances. The mapping can be determined empirically and the look-up table can be stored on the device during manufacture. In an embodiment, an inductance to digital converter (LDC) integrated circuit chip can be coupled to coil 204 to measure the resonant frequency, such as the LDC1612 or LDC 16144 multi-channel 28-bit inductance to digital converter for inductive sensing, fabricated by Texas Instruments Inc., Dallas Tex. USA.

FIG. 3A is a schematic diagram illustrating mutual inductance as a function of air gap distance, according to an embodiment. In this example embodiment, one or more additional inductor coils can be added to target resistance 301 and a mutual inductance between the added coils and coil 204 can be measured. A first current loop includes target resistance 301 and coil 302 (L₁). An eddy current induced in target resistance 301 by electromagnet 202 causes a magnetic field to be generated by coil 302 (L₂) which couples to the magnetic field generated by coil 204. The mutual inductance Lₘ is dependent on the gap distance d. A change in mutual inductance Lₘ due to a change of air gap distance d can be detected by monitoring a change in a nominal resonant frequency of a resonant circuit in the same manner as described in reference to FIGS. 2B and 2C.

FIG. 3B is a schematic diagram of a parallel electrical L-C tank model, according to an embodiment. The L-C tank model includes distance dependent mutual inductance 303 (Lₘ(d)), lumped resistance 304 (Rₚ(d)), which is also distance dependent and lumped sensor capacitance 305 (Cₚ), which includes the added capacitor 205 and lumped capacitance of coil 204, as previously described. The mutual inductance is given by Equation [6]:

Lₘ=k\sqrt{L₁L₂}, [6]

where k is the coupling coefficient and −1≦k≦1, L₁ is the inductance of the first coil and L₂ is the inductance of the second coil.

### Other Example Gap Sensors

In another embodiment, another type of gap sensor can be used. For example, capacitive parallel plate gap sensing can be used by adding one or more capacitive plates to target 201 and electromagnet 202 and using a capacitance detecting circuit (e.g., a tank circuit) to detect changes in mutual capacitance. In another embodiment, capacitive gasket gap sensing can be used. In yet another embodiment, a resistive strain gauge sensing can be used. The strain gauge can be disposed on target 201 and can be used to measure deflection as a result of user preload force. The strain gauge can be coupled to, for example, a Wheatstone bridge or other voltage divider circuit to generate a signal in response to a change of resistance. The change in resistance can be mapped to an air gap distance in a look-up table installed on an electronic device during manufacture. The mapping can be determined empirically.

In an embodiment that uses capacitive sensing, a capacitance-to-digital converter (FDC) based on an LC resonator sensor can be used to detect the air gap distance. A conductive sensor plate is attached to target 201 or electromagnet 202 and to an L-C tank circuit to serve as the capacitive sensor. In active mode, a sine wave or half-sine wave can be used to excite the L-C tank circuit and measures its oscillation frequency. As target 201 approaches the sensor plate, a change in capacitance causes a change in resonant frequency that can be converted to a digital value by an ADC in the FDC. Some example FDC integrated circuits are FDC2214, FDC2212, FDC2114 and FDC2112 fabricated by Texas Instruments Inc., Dallas, Tex. USA.

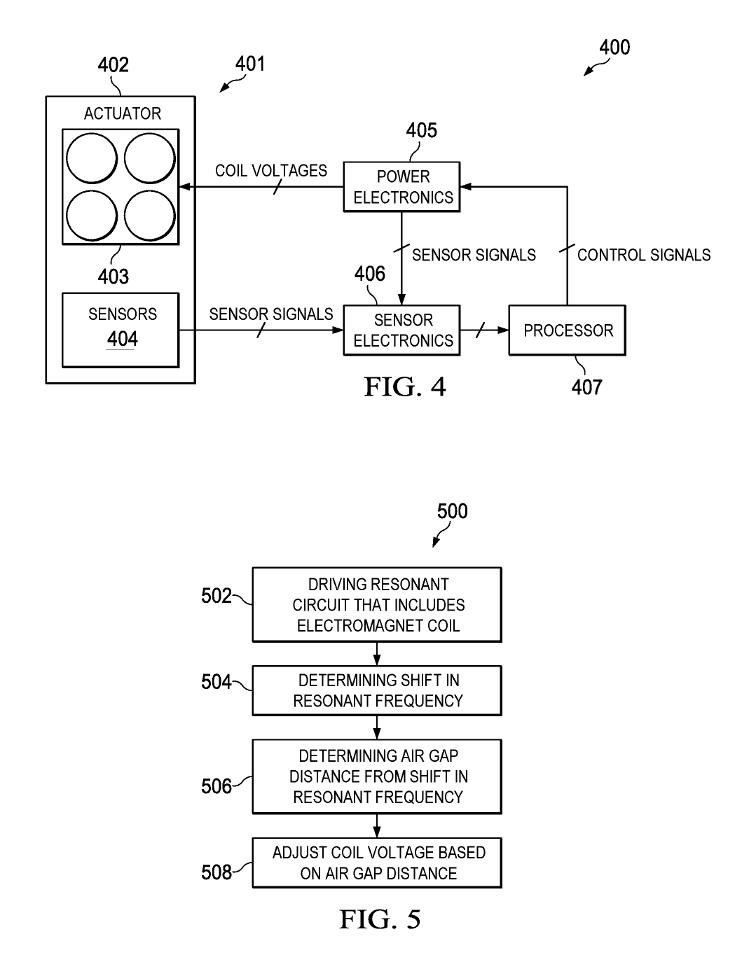

FIG. 4 is a block diagram of an actuator system 400 that uses a multi-dimension, multi-core assembly, according to an embodiment. System 400 can be included in any electronic device that uses an electromagnetic reluctance actuator, including but not limited to a smartphone, notebook computer, tablet computer, wearable computer or any device or system that includes a haptic feedback.

In the example embodiment shown, system 400 includes electromagnetic reluctance actuator 401, which includes housing 402 containing multi-dimension, multi-core assembly 403 and one or more sensors 404. Actuator 401 is coupled to power electronics 405, which provides coil voltages to coils in core assembly 403. Sensor electronics 405 is coupled to actuator 401 and power electronics 405 and receives sensor signals from these components. Controller 407 provides control signals to power electronics 405 and receives sensor signals from sensor electronics 406.

Power electronics 405 can have integrated current sensors and measure the current in each coil in core assembly 403 individually with, for example, a hall-effect based sensor. The armature state of actuator 401 can be monitored using sensors 404 that measure position, acceleration and temperature, or any other desired parameter. Sensor electronics 406 can include various components for conditioning the sensor signals, including but not limited to one or more filters (e.g., low pass filtering) and at least one analog-to-digital converter (ADC). Controller 407 can be central processing unit (CPU) of an electronic device in which the actuator 401 is integrated (e.g., a smart phone), and execute software instructions that implement a closed feedback control algorithm for actuator 401. In an embodiment, controller 407 can include at least one Pulse Width Modulator (PWM) for generating PWM control signals to activate and deactivate coils in core assembly 402 based on sensor signals.

FIG. 5 is a flow diagram illustrating process 500 of air gap sensing, according to an embodiment. Process 500 can be implemented by system 400, as described in reference to FIG. 4.

Process 500 can begin by driving a resonant circuit including a coil to resonance, the coil being an inductive component of an electromagnet (502). For example, a coil of an electromagnetic reluctance actuator can be used in combination with a capacitor with a known capacitance value to form the resonant circuit. The resonant circuit can be driven into oscillation by a driver circuit (e.g., a sinusoidal voltage source) to a reference oscillation frequency. The amplitude and frequency of the drive signal can be selected so as not to generate significant electromagnetic interference in the operating frequency band of the electromagnetic reluctance actuator. In an alternative embodiment, an additional inductor coil can be added to the target and a change in mutual inductance can be measured in a similar manner by a resonant circuit.

Process 500 can continue by determining a shift in the first frequency due to a change in self-inductance of the coil (504). When the self-inductance of the coil changes as the air gap distance changes per Equation [3], the resonant frequency shifts from the reference or nominal resonant frequency. This shift in resonant frequency can be measured by, for example, taking the ratio of the measured resonant frequency with the reference frequency that can be derived from a reference clock (e.g., quartz crystal or externally supplied clock).

The resonant frequency can be measured by transforming the output of the resonant circuit into the frequency domain and looking for the frequency associated with the highest energy. For example, the analog output of the resonant circuit can be converted to digital samples by an analog-to-digital converter (ADC). A processor (e.g., a dedicated controller or central processing unit (CPU)) can then compute a fast Fourier transform on the digital samples and the result can be searched for the frequency associated with the highest energy. In an embodiment, an inductance to digital converter (LDC) integrated circuit chip can be coupled to the coil of the electromagnetic reluctance actuator to measure the resonant frequency, such as the LDC1612 or LDC 16144 multi-channel 28-bit inductance to digital converter for inductive sensing, fabricated by Texas Instruments Inc., Dallas Tex. USA.

Process 500 can continue by determining a gap distance between a ferromagnetic target and the electromagnet based on the shift in resonant frequency (506). For example, a look-up table can be generated that associates a change in frequency (delta frequency) with change in distance (delta x). The delta frequency can be determined from the ratio of the measured resonant frequency and a reference oscillation frequency of the resonant circuit. The delta frequency can then be used to index the look-up table to obtain a corresponding delta distance. The values in the look-up table can be determined empirically during manufacture and stored in cache memory of the electronic device.

Once the airgap is determined, the coil voltage can be adjusted based on the air gap distance (508) to compensate for the change in air gap distance due to user preload force. For example, referring to Equation [2], decreasing the coil voltage will decrease the current flow through the coil, which in turn will decrease the MMF, which in turn will decrease the reluctance force. Equation [2] can be solved for current i. By setting the reluctance force Fᵣₑₗ to a desired value and using the measured air gap distance, the current needed to maintain the desired force reluctance can be determined. The coil voltage can then be adjusted to maintain that current.

A number of embodiments have been described. Nevertheless, it will be understood that various modifications may be made. Elements of one or more embodiments may be combined, deleted, modified, or supplemented to form further embodiments. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A system comprising:
a electromagnet having a core and a coil wrapped around the core; and
a gap sensing circuit coupled to the coil, the gap sensing circuit operable to determine a gap distance between the electromagnet and a ferromagnetic target based on a change of inductance of the coil.

2. The system of claim 1, further comprising:
an electronics component coupled to the gap sensing circuit and operable for adjusting one or more electrical characteristics of the electromagnet based on the determined gap distance.

3. The system of claim 1, wherein the gap sensing circuit further comprises:
a resonant circuit including a capacitor coupled to the coil;
a driver circuit coupled to the resonant circuit, the driver circuit operable for driving the resonant circuit into resonance; and
a frequency detection circuit operable to detect a change in resonant frequency of the resonant circuit and to output a signal indicative of the change in resonant frequency.

4. The system of claim 3, further comprising:
an electronics component coupled to the frequency detection circuit and operable for adjusting one or more electrical characteristics of the actuator based on the detected change in resonant frequency.

5. The system of claim 4, wherein the electronics component adjusts current flow into the coil based on the detected change in resonant frequency.

6. The system of claim 1, wherein the gap sensing circuit is operable to determine a gap distance between the electromagnet and a ferromagnetic target based on a change of mutual inductance of the coil and another coil coupled to the target.

7. The system of claim 1, wherein at least one of the core or target is subdivided to balance at least one of power, settling time or signal strength.

8. A method comprising:
driving a resonant circuit including a coil to resonance, the coil being an inductive component of an electromagnet;
determining a shift in the first frequency due to a change in self-inductance of the coil; and
determining a gap distance between a ferromagnetic target and the electromagnet based on the shift in resonant frequency.

9. The method of claim 7, further comprising:
adjusting one or more electrical characteristics of the electromagnet based on the gap distance.

10. The method of claim 7, where the gap distance is determined from a mapping of resonant frequency or a change in resonant frequency to gap distance.

11. A system comprising:
a mechanically compliant surface;
an electromagnet having a core and a coil operable to magnetically couple to the surface, the electromagnetic arranged opposite a ferromagnetic portion of the surface such that a gap is formed between the surface and the electromagnet; and
a gap sensing circuit coupled to the coil, the gap sensing circuit operable to determine a gap distance between the electromagnet and the ferromagnetic portion based on a change of self-inductance of the coil or a change in mutual inductance between the coil and a second coil.

12. The system of claim 11, further comprising:
an electronics component coupled to the gap sensing circuit and operable for adjusting one or more electrical characteristics of the electromagnet based on the determined gap distance.

13. The system of claim 11, wherein the gap sensing circuit further comprises:
a resonant circuit including a capacitor coupled to the coil;
a driver circuit coupled to the resonant circuit, the driver circuit operable for driving the resonant circuit into resonance; and
a frequency detection circuit operable to detect a change in resonant frequency of the resonant circuit and to output a signal indicative of the change in resonant frequency.

14. The system of claim 13, further comprising:
an electronics component coupled to the frequency detection circuit and operable for adjusting one or more electrical characteristics of the actuator based on the signal.

15. The system of claim 14, wherein the electronics component adjusts current flow into the coil based on the detected change in resonant frequency.

16. The system of claim 11, wherein the gap sensing circuit is operable to determine a gap distance between the electromagnet and a ferromagnetic target based on a change of mutual inductance of the coil and another coil coupled to the target.

17. The system of claim 11, wherein at least one of the core or target is subdivided to balance at least one of power, settling time or signal strength.

18. The system of claim 11, wherein the system is included in an electronic device and is operable to provide haptic feedback through the surface.

19. The system of claim 18, wherein the surface is a touch sensitive display of an electronic device.

20. The system of claim 11, wherein the core is included in a core assembly including a plurality of cores arranged in a grid pattern.
